(19) United States
(12) Patent Application Publication
(10) Pub. No.: US 2026/0119356 A1
(43) Pub. Date: Apr. 30, 2026

(54) METHODS AND APPARATUS FOR TEMPERATURE BASED RE-TRAINING OF MEMORY ACCESS PARAMETERS

(71) Applicant: Intel Corporation, Santa Clara, CA (US)

(72) Inventors: Douglas Benjamin Heymann, Portland, OR (US); Jorge Ulises Martinez Araiza, Beaverton, OR (US); James Alexander McCall, Portland, OR (US)

(73) Assignee: Intel Corporation, Santa Clara, CA (US)

(21) Appl. No.: 19/432,465

(22) Filed: Dec. 24, 2025

(51) Int. Cl. G06F 11/30

(52) U.S. Cl. CPC G06F 11/3058; G06F 11/3037

(57) ABSTRACT

Systems, apparatus, articles of manufacture, and methods are disclosed An example memory includes a temperature sensor to measure a temperature of the memory, machine-readable instructions, and at least one processor circuit to be programmed by the machine-readable instructions to determine whether the temperature difference between the measured temperature and a reference temperature satisfies a threshold; cause training of communication parameters when the temperature difference satisfies the threshold; and update the stored reference temperature to the measured temperature.

### BACKGROUND

Dynamic random-access memory (DRAM) is a component in modern computing platforms, providing the high-bandwidth, low-latency storage used by CPUs, GPUs, and/or other system-on-chip (SoC) devices. As data rates continue to climb, the electrical characteristics of the memory interface become increasingly important. Clock (CK) and address-command (CA) lines are traditionally kept at matched data rates to preserve timing symmetry, while the data (DQ) receive path often becomes unmatched.

### BRIEF DESCRIPTION OF THE DRAWINGS

FIG. 1 is a block diagram of an example implementation of memory circuitry that is to perform temperature-based re-training of memory access parameters.

FIG. 2 is a flowchart representative of example machine readable instructions and/or example operations that may be executed, instantiated, and/or performed by example programmable circuitry to implement the memory circuitry of FIG. 1.

FIG. 3 is a flowchart representative of example machine readable instructions and/or example operations that may be executed, instantiated, and/or performed by example programmable circuitry to implement the memory circuitry of FIG. 1.

FIG. 4 is a graph illustrating prior re-training instances versus training instances incurred using examples disclosed herein.

FIG. 5 is a graph illustrating temperature versus time, showing a steady temperature that remains within a threshold difference such that re-training is avoided.

FIG. 6 is a block diagram of an example processing platform including programmable circuitry structured to execute, instantiate, and/or perform the example machine readable instructions and/or perform the example operations of FIGS. 2-3 to implement the memory circuitry of FIG. 1.

In general, the same reference numbers will be used throughout the drawing(s) and accompanying written description to refer to the same or like parts. The figures are not necessarily to scale.

### DETAILED DESCRIPTION

DDR6 is a next-generation Dynamic Random Access Memory (DRAM) standard which promises significant speed and efficiency boosts over prior standards, such as DDR5. DDR6 introduces higher data rates and tighter timing margins as compared to prior standards. At these tighter timing margins, memory access parameters, such as a data-receive delay (DQ-Rx), can be impacted by the temperature of a memory device. As a result, memory access parameters of a DDR6 memory may be adjusted (e.g., drift) over time. Existing approaches to mitigating temperature drift use a process called re-training to adjust the memory access parameters. Such re-training introduces significant bus downtime and power overhead, as communications are halted while determining the updated memory access parameters. Moreover, such re-training is performed periodically, on a blind basis. That is, the re-training is performed whether or not a change in temperature has actually occurred.

Examples disclosed herein utilize a temperature sensor to enable temperature-driven re-training, such that the downtime associated with re-training is incurred only when the temperature change exceeds a threshold, thereby reducing unnecessary training cycles and improving DDR6 system performance and efficiency. At run time, the host reads the current temperature, compares the current temperature with a stored reference temperature, and triggers re-training only if the temperature difference meets or exceeds a preset (e.g., predefined) threshold. Because the threshold is typically on the order of several degrees Celsius, many previously unnecessary training instances are avoided, thereby reducing bus downtime and power consumption while maintaining accurate delay compensation.

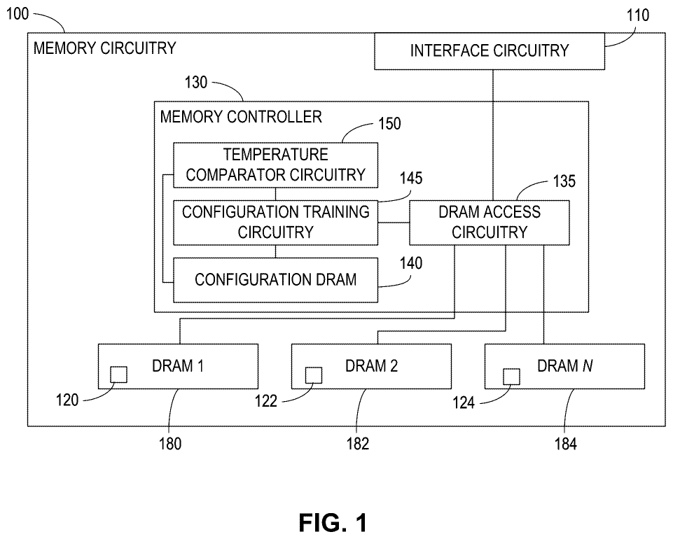

FIG. 1 is a block diagram of example memory circuitry 100 implemented in accordance with teachings of this disclosure to perform temperature-based re-training of memory access parameters. The memory circuitry 100 of FIG. 1 may be a component of a larger computing system. For example, the memory circuitry 100 of FIG. 1 may be implemented as a DDR6 memory that is installed and/or to be installed in a computing device such as a laptop computer, tablet, smart phone, server, mobile device, etc.

The example memory circuitry 100 of FIG. 1 includes interface circuitry 110, temperature sensor(s) 120, 122, 124, a memory controller 130, and DRAM circuits 180, 182, 184. The example memory controller 130 includes DRAM access circuitry 135, a configuration DRAM 140, configuration training circuitry 145, and temperature comparator circuitry 150. The interface circuitry 110 provides the interface between the DRAM circuit(s) and external logic. The temperature sensor(s) 120, 122, 124 measure the temperature of a respective DRAM circuit or, more generally, the memory circuitry 100. The memory controller 130 reads the temperature, retrieves a reference temperature from the configuration DRAM, and triggers the configuration training circuitry 145 when the temperature change exceeds a threshold detected by the temperature comparator circuitry 150. The DRAM access circuitry 135 uses the trained memory access parameters stored in the configuration DRAM to control access to the DRAM circuits. Overall, FIG. 1 illustrates a closed-loop system that monitors temperature and performs training of memory access parameters when required, thereby reducing unnecessary re-training. In some examples, memory access parameters may also be referred to as communication parameters.

As used herein, a DRAM circuit is an individual DRAM chip that stores data and provides internal memory logic. A DRAM chip may provide an amount of memory locations, represented in bits and/or bytes. Multiple DRAM circuits may be implemented in combination with each other to form part of a memory circuit. In this manner, the amount of memory locations available may be greater than the amount of memory provided by a single DRAM circuit. In this manner, the term memory circuitry represents the aggregate of components that provide control, timing, and/or interface functions for a memory controller 130, and one or more DRAM circuitry 180, 182, 184. In practice, the memory circuitry may be implemented as a replaceable memory unit (e.g., a stick of DRAM) that interfaces with a computing system. In such an example, multiple memory circuitries may be utilized by a same computing system. More generally, the term memory is defined as any storage medium capable of retaining data.

The example interface circuitry 110 of the illustrated example of FIG. 1 receives data and command signals from a host controller of a computing device in which the memory circuitry 110 is installed. The interface circuitry 110 forwards such data and/or command signals to the memory controller 130 to enable access to the DRAM circuits 180, 182, 184. The example interface circuitry 110 communicates data to the host controller at the direction of the memory controller 130. In some examples, the interface circuitry 110 performs signal conditioning, level shifting, timing alignment, etc. to enable communications between the host controller and the memory circuitry 100.

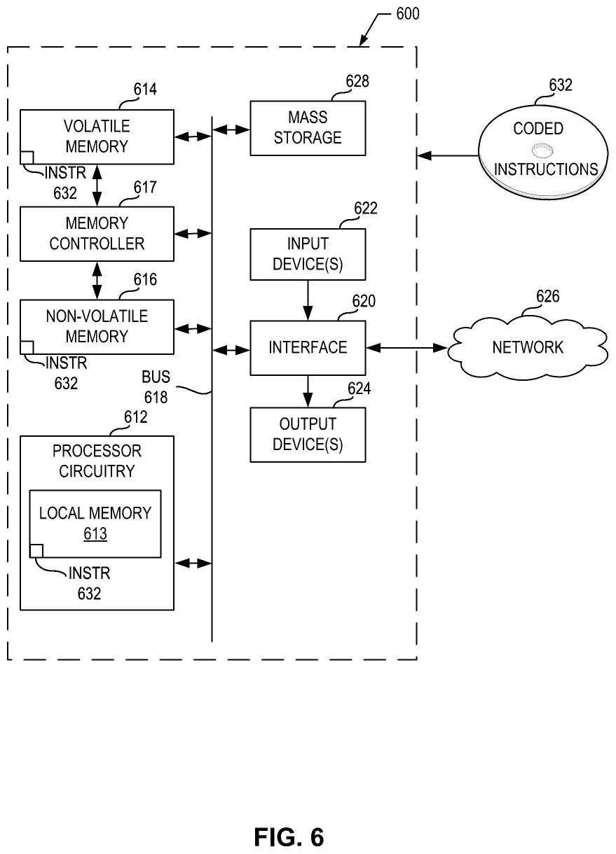

In some examples, the memory circuitry includes means for interfacing. For example, the means for interfacing may be implemented by the interface circuitry 110. In some examples, the interface circuitry 110 may be instantiated by programmable circuitry such as the example programmable circuitry 612 of FIG. 6. In some examples, the interface circuitry 110 may be instantiated by hardware logic circuitry, which may be implemented by an ASIC, XPU, or FPGA circuitry configured and/or structured to perform operations corresponding to the machine readable instructions. Additionally or alternatively, the interface circuitry 110 may be instantiated by any other combination of hardware, software, and/or firmware. For example, the interface circuitry 110 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example temperature sensor(s) 120, 122, 124 of the illustrated example of FIG. 1 detect a temperature of the memory circuitry 100. In the illustrated example of FIG. 1, multiple temperature sensors are utilized, with each temperature sensor being associated with (and/or a component of) a corresponding DRAM circuit 180, 182, 184. For example, a first temperature sensor 120 measures a temperature of a first DRAM 180, a second temperature sensor 122 measures a temperature of a second DRAM 182, and an Nth temperature sensor 124 measures a temperature of the Nth DRAM 184. Each temperature sensor 120, 122, 124 includes a sensing element that produces a voltage or current proportional to a temperature of the sensor. In some examples, this temperature value is stored in a location of the corresponding DRAM circuit, and is then accessible by the temperature comparator circuitry 150 via the DRAM access circuitry 135. The sensor output is accessed by the temperature comparator circuitry 150, which stores the sensed temperature and uses the sensed temperature to determine a temperature difference relative to a prior stored reference temperature in the configuration DRAM 140. When the temperature difference exceeds a predefined threshold, the temperature comparator circuitry 150 initiates re-training of memory access parameters via the configuration training circuitry 145.

While in the illustrated example of FIG. 1, multiple temperature sensors are shown, each in connection with a respective DRAM circuit, in some examples, the temperature sensor(s) may be implemented separately from the DRAM circuit(s). For example, a single temperature sensor may be implemented at the board level, and provide a temperature representative of the memory circuitry 100 as a whole. Moreover, multiple temperature sensors might be implemented separately from, but nonetheless associated with, respective DRAM circuit(s). That is, the temperature sensor(s) may be implemented in close physical proximity to (e.g., adjacent to) a corresponding DRAM circuit. In some examples, a temperature sensor may be implemented physically adjacent to two or more DRAM circuits and be used to represent the temperature of those two or more DRAM circuits.

In some examples, the memory circuitry includes means for sensing a temperature. For example, the means for sensing a temperature may be implemented by temperature sensor(s) 120, 122, 124. In some examples, the temperature sensor(s) 120, 122, 124 may be instantiated by programmable circuitry such as the example programmable circuitry 612 of FIG. 6. In some examples, the temperature sensor(s) 120, 122, 124 may be instantiated by hardware logic circuitry, which may be implemented by an ASIC, XPU, or FPGA configured and/or structured to perform operations corresponding to the machine readable instructions. Additionally or alternatively, the temperature sensor(s) 120, 122, 124 may be instantiated by any other combination of hardware, software, and/or firmware. For example, the temperature sensor(s) 120, 122, 124 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example memory controller 130 of the illustrated example of FIG. 1 controls access to the DRAM circuits 180, 182, 184. The memory controller 130 includes the DRAM access circuitry 135, the configuration DRAM 140, the configuration training circuitry 145, and the temperature comparator circuitry 150. The DRAM access circuitry 135 receives memory access requests from the host or internal logic and schedules transactions according to timing parameters stored in the configuration DRAM 140. When triggered by the temperature comparator circuitry 150, the configuration training circuitry 145 calculates communications parameters (e.g., CK-CA and DQ-DQS delay values), which are stored in the configuration DRAM 140 for later use by the DRAM access circuitry 135. When the temperature comparator circuitry 150 indicates a temperature change that exceeds a predefined threshold, the memory controller 130 initiates a re-training sequence. This re-training sequence halts memory traffic, recomputes updated delay parameters, introduces a configurable wait period, programs the new delay values into the DRAM, and then resumes normal traffic. The memory controller 130 updates the stored reference temperature in the temperature register after each re-training event.

In some examples, the memory circuitry includes means for controlling memory. For example, the means for controlling memory may be implemented by memory controller 130. In some examples, the memory controller 130 may be instantiated by programmable circuitry such as the example programmable circuitry 612 of FIG. 6. In some examples, the memory controller 130 may be instantiated by hardware logic circuitry, which may be implemented by an ASIC, XPU, or FPGA circuitry configured and/or structured to perform operations corresponding to the machine readable instructions. Additionally or alternatively, the memory controller 130 may be instantiated by any other combination of hardware, software, and/or firmware. For example, the memory controller 130 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The DRAM access circuitry 135 of the illustrated example of FIG. 1 interfaces with the DRAM circuits 180, 182, 184. The DRAM access circuitry 135 receives control signals from the memory controller 130. The DRAM access circuitry 135 reads memory access parameters from the configuration DRAM 140, and interfaces with the DRAM circuits 180, 182, 184 based on those memory access parameters. In examples disclosed herein, such parameters include delay settings such as CK-CA and DQ-DQS delays. However, any other parameters may additionally or alternatively be used. The DRAM access circuitry 135 uses the parameters to interface with the DRAM circuits 180, 182, 184.

In some examples, the memory circuitry includes means for accessing memory. For example, the means for accessing memory may be implemented by DRAM access circuitry 135. In some examples, the DRAM access circuitry 135 may be instantiated by programmable circuitry such as the example programmable circuitry 612 of FIG. 6. In some examples, the DRAM access circuitry 135 may be instantiated by hardware logic circuitry, which may be implemented by an ASIC, XPU, or FPGA circuitry configured and/or structured to perform operations corresponding to the machine readable instructions. Additionally or alternatively, the DRAM access circuitry 135 may be instantiated by any other combination of hardware, software, and/or firmware. For example, the DRAM access circuitry 135 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example configuration DRAM 140 of the illustrated example of FIG. 1 is implemented by any memory, storage device and/or storage disc for storing data such as, for example, flash memory, magnetic media, optical media, solid state memory, hard drive(s), thumb drive(s), etc. The data stored in the example configuration DRAM 140 may be in any data format such as, for example, binary data, etc. While, in the illustrated example, the configuration DRAM 140 is illustrated as a single device, the example configuration DRAM 140 and/or any other data storage devices described herein may be implemented by any number and/or type(s) of memories. In the illustrated example of FIG. 1, the example configuration DRAM 140 stores memory access parameters used by the DRAM access circuitry 135, which are trained by the configuration training circuitry 145. In examples disclosed herein, the configuration DRAM 140 may be implemented as a dedicated DRAM module or as any other storage technology, such as a register.

The configuration training circuitry 145 of the illustrated example of FIG. 1 accesses a training enable signal from the temperature comparator circuitry 150. The training enable signal causes the configuration training circuitry 145 to perform a re-training operation. The re-training operation begins with the halting of memory read and write traffic controlled by the DRAM access circuitry 135. The example configuration training circuitry 145 computes updated memory access parameters, such as CK-CA and DQ-DQS delay values, based on the current temperature measured by the temperature sensor(s) 120, 122, 124 and the stored reference temperature. Computation is performed using stored delay delta data in the configuration DRAM 140 or an internal calibration table. After computation, the configuration training circuitry 145 writes the new delay values back to the configuration DRAM 140 and signals the DRAM access circuitry 135 to resume normal operation.

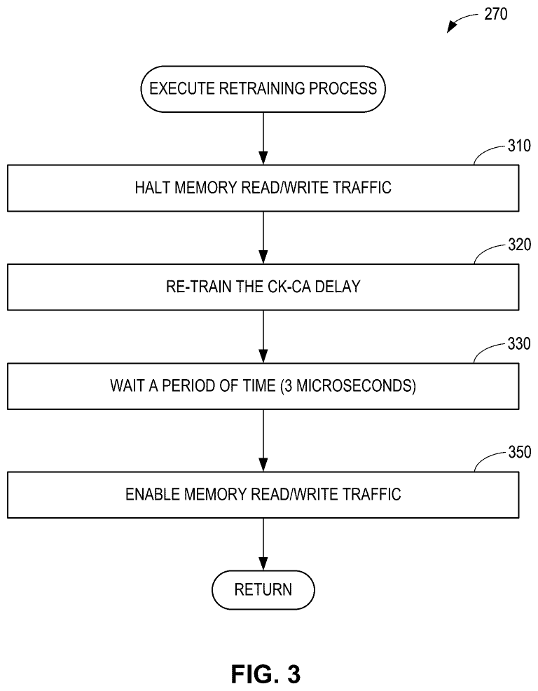

In some examples, the memory circuitry 100 includes means for training memory access parameters. For example, the means for training memory access parameters may be implemented by configuration training circuitry 145. In some examples, the configuration training circuitry 145 may be instantiated by programmable circuitry such as the example programmable circuitry 612 of FIG. 6. For instance, the configuration training circuitry 145 may be instantiated by the example microprocessor 600 of FIG. 6 executing machine executable instructions such as those implemented by at least blocks 310, 320, 330, 350 of FIG. 3. In some examples, the configuration training circuitry 145 may be instantiated by hardware logic circuitry, which may be implemented by an ASIC, XPU, or FPGA circuitry configured and/or structured to perform operations corresponding to the machine readable instructions. Additionally or alternatively, the configuration training circuitry 145 may be instantiated by any other combination of hardware, software, and/or firmware. For example, the configuration training circuitry 145 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The temperature comparator circuitry 150 of the illustrated example of FIG. 1 determines whether training of the memory access parameters by the configuration training circuitry 145 should occur. The temperature comparator circuitry 150 accesses a temperature value from the temperature sensor(s) 120, 122, 124 and a stored reference temperature from a register or memory (e.g., the configuration DRAM 140). The temperature comparator circuitry 150 calculates the temperature difference between the current reading and the stored reference temperature. In examples disclosed herein, the temperature difference is computed in degrees Celsius. However, any other unit of measurement may additionally or alternatively be used. The temperature comparator circuitry 150 compares the calculated difference to a predetermined threshold. When the temperature difference exceeds the threshold, the temperature comparator circuitry 150 signals the configuration training circuitry 145 to initiate re-training of the memory access parameters. If the temperature difference remains below the threshold, the temperature comparator circuitry 150 allows the memory circuitry 100 to continue normal operation without re-training.

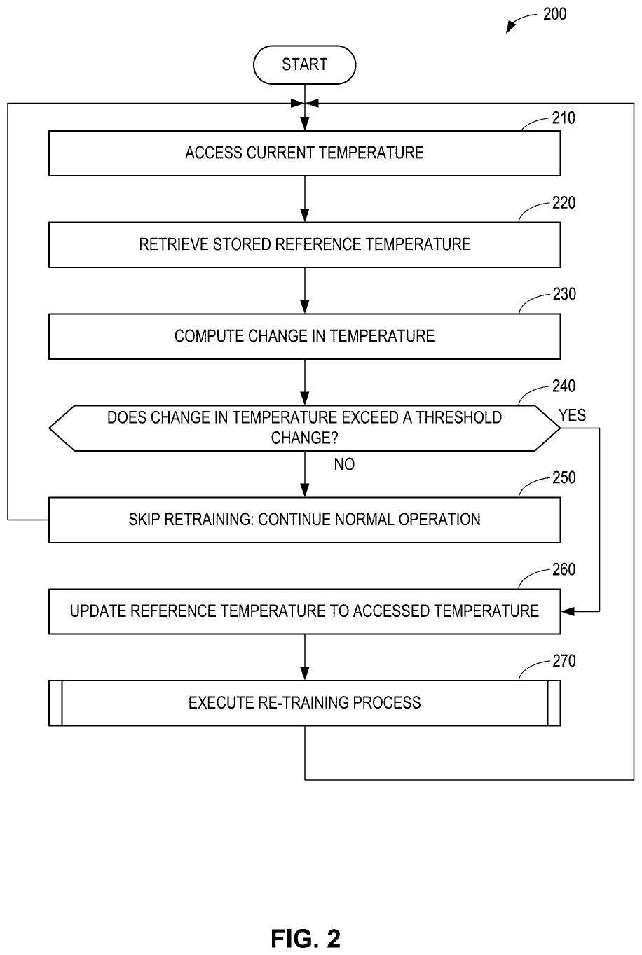

In some examples, the memory circuitry 100 includes means for comparing temperatures. For example, the means for comparing temperatures may be implemented by temperature comparator circuitry 150. In some examples, the temperature comparator circuitry 150 may be instantiated by programmable circuitry such as the example programmable circuitry 612 of FIG. 6. For instance, the temperature comparator circuitry 150 may be instantiated by the example microprocessor 600 of FIG. 6 executing machine executable instructions such as those implemented by at least blocks 210, 220, 230, 240 of FIG. 2. In some examples, the temperature comparator circuitry 150 may be instantiated by hardware logic circuitry, which may be implemented by an ASIC, XPU, or FPGA circuitry configured and/or structured to perform operations corresponding to the machine readable instructions. Additionally or alternatively, the temperature comparator circuitry 150 may be instantiated by any other combination of hardware, software, and/or firmware. For example, the temperature comparator circuitry 150 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the memory circuitry 100 is illustrated in FIG. 1, one or more of the elements, processes, and/or devices illustrated in FIG. 1 may be combined, divided, re-arranged, omitted, eliminated, and/or implemented in any other way. Further, the example DRAM access circuitry 135, the example configuration training circuitry 145, the temperature comparator circuitry 150, and/or, more generally, the example memory controller 130 of FIG. 1, may be implemented by hardware alone or by hardware in combination with software and/or firmware. Thus, for example, any of the example DRAM access circuitry 135, the example configuration training circuitry 145, the temperature comparator circuitry 150, and/or, more generally, the example memory controller 130, could be implemented by programmable circuitry, such as one or more chiplets, one or more processor cores, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example memory circuitry 100 of FIG. 1 may include one or more elements, processes, and/or devices in addition to, or instead of, those illustrated in FIG. 1, and/or may include more than one of any or all of the illustrated elements, processes and devices.

Flowchart(s) representative of example machine readable instructions, which may be executed by programmable circuitry to implement and/or instantiate the memory circuitry 100 of FIG. 1 and/or representative of example operations which may be performed by programmable circuitry to implement and/or instantiate the memory circuitry 100 of FIG. 1, are shown in FIGS. 2-3. The machine readable instructions may be one or more executable programs or portion(s) of one or more executable programs for execution by programmable circuitry such as the programmable circuitry 612 shown in the example processor platform 600 discussed below in connection with FIG. 6. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 2-3, many other methods of implementing the example memory circuitry 100 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, a chiplet and/or an array of chiplets, etc.)). As used herein, programmable circuitry includes any type(s) of circuitry that may be programmed to perform a desired function such as, for example, a CPU, a core, a chiplet, an array of chiplets, a GPU, a VPU, and/or an FPGA. The programmable circuitry may include one or more CPUs, one or more cores, one or more chiplets, one or more GPUs, one or more VPUs, and/or one or more FPGAs located in the same package (e.g., the same integrated circuit (IC) package or in two or more separate housings), one or more CPUs, one or more cores, one or more chiplets, one or more GPUs, one or more VPUs, and/or one or more FPGAs in a single machine, multiple CPUs, GPUs, VPUs, and/or FPGAs distributed across multiple servers of a server rack, and/or multiple CPUs, cores, chiplets, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 2-3 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 2 is a flowchart representative of example machine readable instructions and/or example operations that may be executed, instantiated, and/or performed by programmable circuitry to determine whether to perform training of memory access parameters. The example instructions 200 of FIG. 2 are executed periodically (e.g., every one hundred and twenty eight milliseconds), but may additionally or alternatively be executed a-periodically (e.g., upon detection of a change in a power state of a computing device).

At block 210, the example temperature comparator circuitry 150 accesses the present temperature. The temperature comparator circuitry 150 reads a value from the temperature sensor(s) 120, 122, 124. The retrieved temperature is used as input for subsequent comparison. In examples disclosed herein, the temperature is measured in degrees Celsius. However, any other unit of measurement may additionally or alternatively be used.

At block 220 in FIG. 2, the example temperature comparator circuitry 150 retrieves the stored reference temperature. This value is stored in a memory location (e.g., the configuration DRAM 140) or a register that records the temperature at the time the last configuration of memory access parameters was performed. The example temperature comparator circuitry 150 accesses that location, reads the reference temperature, and uses the stored reference temperature in a subsequent comparison step.

At block 230, the example temperature comparator circuitry 150 computes a change in temperature using the current temperature (identified at block 210), and the reference temperature (retrieved at block 220). The example temperature comparator circuitry 150 then subtracts the reference temperature from the current temperature to derive the temperature change. In some examples, an absolute value of the temperature change is identified.

At block 240, the example temperature comparator circuitry 150 determines whether the temperature change meets or exceeds a threshold change. In some examples, the threshold is represented in degrees Celsius (e.g., allow no more than a half degree temperature change before re-training). However, in some other examples, the threshold change is represented using a percentage change (e.g., allow no more than a half percent change before re-training). In some examples, multiple thresholds are used, one corresponding to a positive increase in temperature, and another corresponding to a decrease in temperature. Using multiple thresholds (e.g., one for increasing temperatures and one for decreasing temperatures) allows for different sensitivities to be used for increasing versus decreasing temperatures.

If the temperature change does not meet or exceed the threshold, no re-training is performed. In this manner, the memory circuit 100 continues normal operation (block 250) (e.g., without incurring re-training delays), while continuing to monitor for a temperature change indicating that re-training is to be performed.

If the temperature difference meets or exceeds the threshold, the example temperature comparator circuitry 150 causes the storage of the current temperature as the reference temperature. (Block 260). Storing the accessed temperature as the reference temperature ensures that subsequent comparisons are made using the correct temperature at the time that the most recent re-training was performed. In some examples, the updating of the reference temperature is delayed until after the execution of the re-training process at block 270. In some examples, the reference temperature is stored in a dedicated register located in the configuration DRAM 140, so that the comparator can fetch it without incurring an external bus transaction.

At block 270, the example temperature comparator circuitry 150 instructs the configuration training circuitry 145 to perform re-training of the memory access parameters. An example process for re-training the memory access parameters is described below in connection with FIG. 3. After re-training, control returns to block 210, where continuous monitoring of the temperature may be performed. In some examples, a wait operation may be utilized to delay the next check of the temperature (e.g., at block 210). The polling interval can be set by a parameter stored in the configuration DRAM 140 such as, for example, a polling period configuration value. In addition to the periodic poll, the same temperature-driven logic may be invoked automatically when the host exits a pre-charge power-down (PPD) or self-refresh (SR) state, ensuring that the delay parameters are updated in a timely fashion after a state change.

FIG. 3 is a flowchart representative of example machine readable instructions and/or example operations that may be executed, instantiated, and/or performed by programmable circuitry to re-train memory access parameters, specifically the CK-CA delay. The example instructions 270 of FIG. 3 begin at block 310, when the example configuration training circuitry 145 halts memory read/write traffic. The stop signal disables the read/write command pipeline and gates the bus clock, preventing any further memory accesses until the re-training routine completes.

At block 320 of FIG. 3, the example configuration training circuitry 145 re-trains the memory access parameters including, for example, a CK-CA delay. The example configuration training circuitry 145 accesses the current memory access parameters from the configuration DRAM 140 and identifies new memory access parameters to be used. Such determination of new memory access parameters may be based on, for example, the measured temperature (e.g., from the temperature sensor), or by operating the DRAM 180, 182, 184 in a configuration mode and measuring operational characteristics for determination of the memory access parameters. The example configuration training circuitry 145 writes the updated memory access parameters to the configuration DRAM 140 and then supplies the new value to the DRAM access circuitry 135 for use in subsequent memory operations.

At block 330 of FIG. 3, the example configuration training circuitry 145 waits a period of time. In examples disclosed herein, the delay is three microseconds, although the interval may be configured to any other delay. This pause allows the memory interface to stabilize before further memory access operations are performed using the newly identified memory access parameters.

At block 350, the example configuration training circuitry 145 re-enables memory read/write traffic. After completing the re-training routine, the example configuration training circuitry 145 allows normal read and write operations to resume. This action restores normal data traffic on the memory interface, but using the newly determined memory access parameters.

The examples above are described in the context of a single temperature sensor (e.g., a single on-die temperature sensor that supplies a temperature representative of multiple DRAM circuits). However, other implementations are also possible. For example, when the memory circuitry contains multiple DRAM chips, each DRAM may be equipped with a respective temperature sensor and operate using a set of communication parameters that is specific to (e.g., isolated for use with) that DRAM. The memory controller first accesses the individual sensor(s) 120, 122, 124 for each DRAM, accesses the corresponding reference temperature from a per-DRAM register in the configuration DRAM 140, and determines whether a temperature difference for the DRAM meets or exceeds a threshold temperature change.

In some examples, temperatures may be treated in the aggregate. That is, the temperatures of multiple temperature sensors 120, 122, 124 may be averaged or be otherwise processed to identify a representative temperature of the DRAMs of the memory circuitry. The threshold temperature change may be represented as a single value across all DRAMs, or may be represented as multiple values, each specific to a respective DRAM circuit. When the temperature change of a DRAM circuit meets or exceeds the threshold temperature change, retraining of the communication parameters for that DRAM may be triggered. In some examples, this per-DRAM retraining path updates the communication parameters associated with an individual DRAM (e.g., a first DRAM might use communication parameters that are separate from the communication parameters of a second DRAM), thereby allowing each DRAM to operate with a communication parameter set that is matched to its own thermal state while the rest of the memory circuitry remains unaffected.

Various strategies might be utilized to determine whether to trigger re-training communication parameters specific to a single DRAM circuit, versus re-triggering of communication parameters across multiple DRAM circuits. For example, when one DRAM circuit is identified for re-training, multiple DRAM circuits (e.g., all DRAM circuits) might be re-trained in concert with each other. Performing this joint re-training reduces the delays incurred by halting of memory traffic during the re-training process.

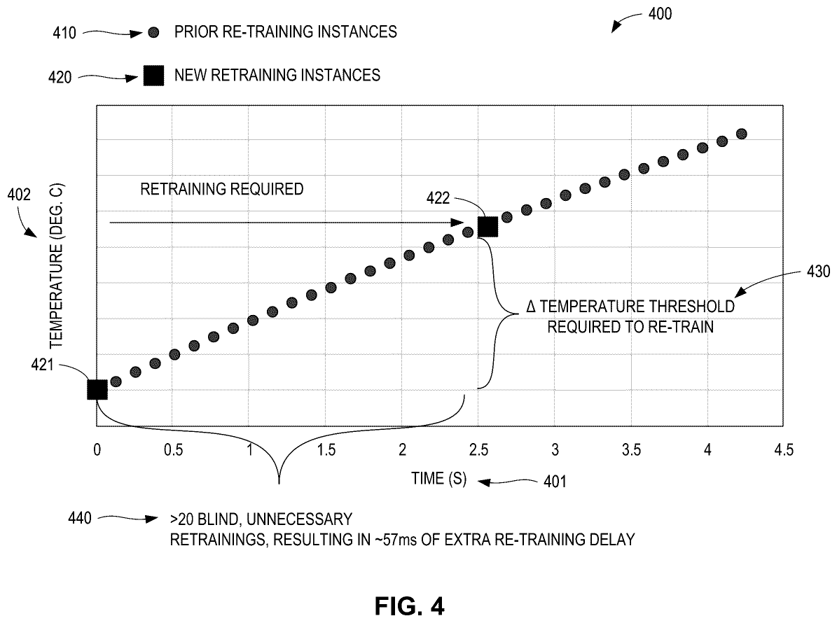

FIG. 4 is a graph 400 that compares the frequency of memory-training events before and after applying the temperature-driven re-training logic. Graph 400 shows time (horizontal axis 401, in seconds) versus temperature (vertical axis 402, in degrees C.). Prior re-training instances, represented by circular markers 410, are plotted at the instants (and temperature at that instant) when conventional periodic training would have been performed. New re-training instances, marked by square symbols 420, indicate the events triggered only when the temperature change exceeds the threshold line 430.

The threshold 430 is drawn at the temperature difference that, when exceeded, causes the controller to initiate a re-training cycle. The area between the two square markers 421, 422 illustrates the reduction in training frequency; in the illustrated example, roughly 20 training events that would have occurred every ˜128 ms are avoided. The amount of time 440, shown as the horizontal span between successive new re-training events, quantifies the duration over which the training logic avoids unnecessary re-training, yielding an estimated 57 μs of avoided bus-downtime. Together, these elements demonstrate how the closed-loop method dramatically lowers re-training overhead while maintaining timing integrity.

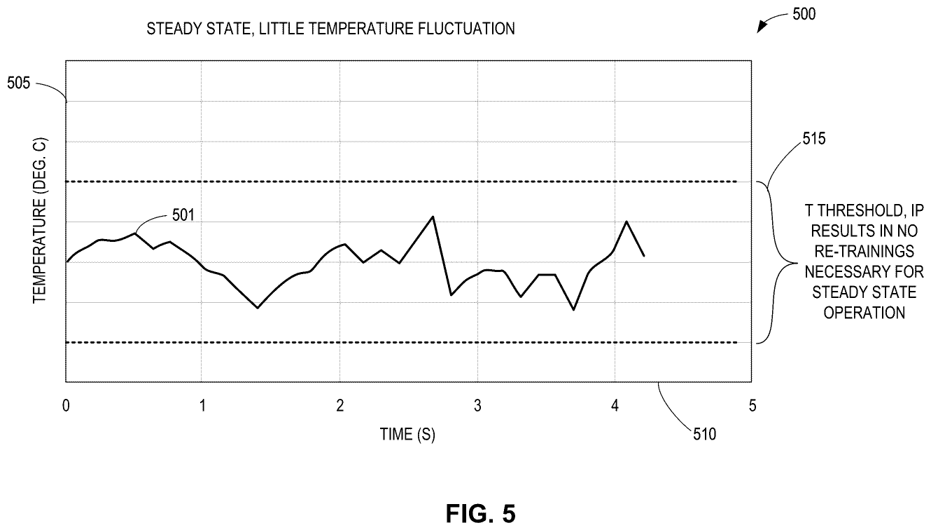

FIG. 4 illustrates an example where a computing device is increasing in temperature at a relatively steady rate to illustrate the benefit of the example approaches disclosed herein. However, many real-world computing platforms generally operate in a steady-state temperature range, even further improving the benefits of examples disclosed herein. For example, a laptop or a server rack that is under a constant workload, or a mobile device that has reached thermal equilibrium after an initial warm-up period, will generally experience small temperature variations over the course of minutes or even hours. In such scenarios, the temperature-driven re-training logic would be triggered far less frequently than with a blind, periodic scheme. As is illustrated in FIG. 5, below, the temperature remains within the predefined tolerance band, so no re-training events occur for extended periods. This steady-state behavior eliminates bus downtime, reduces power consumption, and improves overall system performance

FIG. 5 is a diagram 500 illustrating steady state temperature and the avoidance of additional re-training operations. The illustrated example of FIG. 5 shows temperature plotted over time. The vertical axis 505 indicates temperature in degrees Celsius, while the horizontal axis 510 represents time in seconds. The temperature 501 remains within a temperature range 515 for an extended period of time. This steady state behavior allows extended periods of time (e.g., several seconds, minutes, etc.) where re-training is avoided, thereby improving the performance of the computing device in which it is implemented.

FIG. 6 is a block diagram of an example programmable circuitry platform 600 structured to execute and/or instantiate the example machine-readable instructions and/or the example operations of FIGS. 2-3 to implement the memory controller 130 and/or more generally, the memory circuitry 100 of FIG. 1. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, VPUs, DSPs, and/or microcontrollers from any desired family or manufacturer. The programmable circuitry 612 may be implemented by one or more semiconductor based (e.g., silicon based) devices.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. The memory controller 617 may be implemented by the example memory controller 130 of FIG. 1. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIGS. 2-3, may be stored in the mass storage device 628, in the volatile memory 614, in the non-volatile memory 616, and/or on at least one non-transitory computer readable storage medium such as a CD or DVD which may be removable. Such instructions may be accessible to the memory controller 130.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real-world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, chiplets that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that trigger memory access parameter re-training only when the temperature change exceeds a threshold, thereby avoiding unnecessary re-training cycles when the temperature remains unchanged. Disclosed systems, apparatus, articles of manufacture, and methods improve the efficiency of using a computing device by eliminating the bus downtime and power consumption normally incurred by periodic, blind re-training. Examples disclosed herein also extend the duration of uninterrupted operation by saving the time that would otherwise be incurred performing periodic re-training. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to methods and apparatus for temperature based re-training of memory access parameters are disclosed herein. Further examples and combinations thereof include the following:

Example 1 includes a memory comprising a temperature sensor to measure a temperature of the memory, machine-readable instructions, at least one processor circuit to be programmed by the machine-readable instructions to determine whether a temperature difference between the measured temperature and a reference temperature satisfies a threshold, cause training of communication parameters when the temperature difference satisfies the threshold, and update the reference temperature to the measured temperature.

Example 2 includes the memory of example 1, wherein one or more of the at least one processor circuit is to access the reference temperature from a temperature register, and to update the reference temperature by causing storage of the measured temperature in the temperature register.

Example 3 includes the apparatus of any one or more of examples 1-2, wherein to re-train the communication parameters, one or more of the at least one processor circuit is to halt memory read traffic and write traffic, compute updated communication parameters, apply the updated communication parameters, delay at least a predetermined amount of time, and resume memory read traffic and write traffic according to the communication parameters.

Example 4 includes the memory of example 3, wherein the communication parameters include a CK-CA delay value.

Example 5 includes the apparatus of any one or more of examples 1-4, wherein one or more of the at least one processor circuit is to cause the training after detection of a change of a power state.

Example 6 includes the apparatus of any one or more of examples 1-5, wherein one or more of the at least one processor circuit is to wait a time interval after the determination of whether the temperature difference meets or exceeds the threshold, and access a subsequent temperature from the temperature sensor after waiting the time interval.

Example 7 includes the memory of example 6, wherein the time interval is based on the measured temperature.

Example 8 includes at least one non-transitory computer readable medium comprising instructions to cause at least one processor circuit to at least determine whether a temperature difference between a measured temperature of a memory and a reference temperature satisfies a threshold, cause re training of communication parameters when the temperature difference satisfies the threshold, and update the reference temperature to the measured temperature.

Example 9 includes the at least one non-transitory computer readable medium of example 8, wherein instructions cause the at least one processor circuit to access the reference temperature from a temperature register, and cause storage of the measured temperature in the temperature register.

Example 10 includes the at least one non-transitory computer readable medium of any one or more of examples 8-9, wherein the instructions cause the at least one processor circuit to halt memory read traffic and write traffic, compute updated communication parameters, apply the updated communication parameters, delay at least a predetermined amount of time, and resume memory read traffic and write traffic.

Example 11 includes the at least one non-transitory computer readable medium of example 10, wherein the communication parameters include a CK-CA delay value.

Example 12 includes the at least one non-transitory computer readable medium of any one or more of examples 8-11, wherein the instructions cause the at least one processor circuit to cause re-training after detection of a change in a power state.

Example 13 includes the at least one non-transitory computer readable medium of any one or more of examples 8-12, wherein the instructions cause the at least one processor circuit to wait a predetermined time interval after determining whether the temperature difference meets or exceeds the threshold before a subsequent temperature is accessed.

Example 14 includes the at least one non-transitory computer readable medium of example 13, wherein the time interval is based on the measured temperature.

Example 15 includes an apparatus comprising means for determining a temperature difference between a measured temperature of a temperature sensor, and a reference temperature, the means for determining to determine whether the temperature difference satisfies a threshold, and means for training to train communication parameters when the temperature difference satisfies the threshold, the means for training to update the reference temperature to the measured temperature.

Example 16 includes the apparatus of example 15, wherein the determining of the temperature difference includes reading the reference temperature from a temperature register, and the updating of the reference temperature includes causing storage of the measured temperature in the temperature register.

Example 17 includes the apparatus of any one or more of examples 15-16, wherein the means for training is to halt memory read traffic and write traffic, compute updated communication parameters, delay at least a predetermined amount of time, apply the updated communication parameters, and resume memory read traffic and write traffic.

Example 18 includes the apparatus of example 17, wherein the communication parameters include a CK-CA delay value.

Example 19 includes the apparatus of any one or more of examples 15-18, wherein the means for training is to train the communication parameters after detection of a change from a power state.

Example 20 includes the apparatus of any one or more of examples 15-19, wherein the means for determining is to wait a predetermined time interval after determining whether the temperature difference meets or exceeds the threshold before accessing a subsequent temperature.

Example 21 includes the apparatus of example 20, wherein the time interval is based on the measured temperature.

Example 22 includes a method for temperature driven re training of a memory device, the method comprising determining a temperature difference between a measured temperature of a temperature sensor, and a reference temperature, determining whether the temperature difference satisfies a threshold, causing re training of communication parameters when the temperature difference satisfies the threshold, and updating the reference temperature to the measured temperature.

Example 23 includes the method of example 22, wherein the determining of the temperature difference includes reading the reference temperature from a temperature register, and the updating of the reference temperature includes causing storage of the measured temperature in the temperature register.

Example 24 includes the method of any one or more of examples 22-23, wherein the re training of the communication parameters includes halting memory read traffic and write traffic, computing updated communication parameters, applying the updated communication parameters, delaying at least a predetermined amount of time, and resuming memory read traffic and write traffic.

Example 25 includes the method of example 24, wherein the communication parameters include a CK-CA delay value.

Example 26 includes the method of any one or more of examples 22-25, including causing training after detection of a change from a power state.

Example 27 includes the method of any one or more of examples 22-26, including waiting a predetermined time interval after determining whether the temperature difference meets or exceeds the threshold before accessing a subsequent temperature.

Example 28 includes the method of example 27, wherein the time interval is based on the measured temperature.

Example 29 includes an apparatus comprising means to perform a method as defined in any preceding example.

Example 30 includes machine-readable storage including machine-readable instructions, when executed, to implement a method or realize an apparatus as defined in any preceding example.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A memory comprising:
a temperature sensor to measure a temperature of the memory;
machine-readable instructions;
at least one processor circuit to be programmed by the machine-readable instructions to:
determine whether a temperature difference between the measured temperature and a reference temperature satisfies a threshold;
cause training of communication parameters when the temperature difference satisfies the threshold; and
update the reference temperature to the measured temperature.

2. The memory of claim 1, wherein one or more of the at least one processor circuit is to access the reference temperature from a temperature register, and to update the reference temperature by causing storage of the measured temperature in the temperature register.

3. The memory of claim 1, wherein to re-train the communication parameters, one or more of the at least one processor circuit is to:
halt memory read traffic and write traffic;
compute updated communication parameters;
apply the updated communication parameters;
delay at least a predetermined amount of time; and
resume memory read traffic and write traffic according to the communication parameters.

4. The memory of claim 3, wherein the communication parameters include a CK-CA delay value.

5. The memory of claim 1, wherein one or more of the at least one processor circuit is to cause the training after detection of a change of a power state.

6. The memory of claim 1, wherein one or more of the at least one processor circuit is to:
wait a time interval after the determination of whether the temperature difference meets or exceeds the threshold; and
access a subsequent temperature from the temperature sensor after waiting the time interval.

7. The memory of claim 6, wherein the time interval is based on the measured temperature.

8. At least one non-transitory computer readable medium comprising instructions to cause at least one processor circuit to at least:
determine whether a temperature difference between a measured temperature of a memory and a reference temperature satisfies a threshold;
cause re-training of communication parameters when the temperature difference satisfies the threshold; and
update the reference temperature to the measured temperature.

9. The at least one non-transitory computer readable medium of claim 8,
wherein instructions cause the at least one processor circuit to access the reference temperature from a temperature register, and cause storage of the measured temperature in the temperature register.

10. The at least one non-transitory computer readable medium of claim 8,
wherein the instructions cause the at least one processor circuit to:
halt memory read traffic and write traffic;
compute updated communication parameters;
apply the updated communication parameters;
delay at least a predetermined amount of time; and
resume memory read traffic and write traffic.

11. The at least one non-transitory computer readable medium of claim 10, wherein the communication parameters include a CK-CA delay value.

12. The at least one non-transitory computer readable medium of claim 8, wherein the instructions cause the at least one processor circuit to cause re-training after detection of a change in a power state.

13. The at least one non-transitory computer readable medium of claim 8, wherein the instructions cause the at least one processor circuit to wait a predetermined time interval after determining whether the temperature difference meets or exceeds the threshold before a subsequent temperature is accessed.

14. The at least one non-transitory computer readable medium of claim 13, wherein the time interval is based on the measured temperature.

15. An apparatus comprising:
means for determining a temperature difference between a measured temperature of a temperature sensor, and a reference temperature, the means for determining to determine whether the temperature difference satisfies a threshold; and
means for training to train communication parameters when the temperature difference satisfies the threshold, the means for training to update the reference temperature to the measured temperature.

16. The apparatus of claim 15, wherein the determining of the temperature difference includes reading the reference temperature from a temperature register, and the updating of the reference temperature includes causing storage of the measured temperature in the temperature register.

17. The apparatus of claim 15, wherein the means for training is to halt memory read traffic and write traffic, compute updated communication parameters, delay at least a predetermined amount of time, apply the updated communication parameters, and resume memory read traffic and write traffic.

18. The apparatus of claim 17, wherein the communication parameters include a CK-CA delay value.

19. The apparatus of claim 15, wherein the means for training is to train the communication parameters after detection of a change from a power state.

20. The apparatus of claim 15, wherein the means for determining is to wait a predetermined time interval after determining whether the temperature difference meets or exceeds the threshold before accessing a subsequent temperature.
